(19) United States
(12) Patent Application Publication
(10) Pub. No.: US 2007/0154585 A1
(43) Pub. Date: Jul. 5, 2007

(54) Calibration sleeve for extruded plastic pipes

(76) Inventors: Jorg Schmuhl, Konigs Wusterhausen (DE); Brigitte Diekhaus, Bielefeld (DE); Rolf Michels, Bad Oeynhausen (DE); Jorg Moller, Bunde (DE)

Correspondence Address: SHLESINGER, ARKWRIGHT & GARVEY LLP, 1420 KING STREET, SUITE 600, ALEXANDRIA, VA, 22314, US

(21) Appl. No.: 11/642,966

(22) Filed: Dec. 21, 2006

(30) Foreign Application Priority Data
Dec. 22, 2005 (DE) 10 2005 062 138.4

(51) Int. Cl. B29C 47/92

(52) U.S. Cl. 425/104; 425/445; 425/461

(57) ABSTRACT

Calibration sleeve for extruded plastic pipes with a first layer of flexible straps that run diagonal to the longitudinal axis of the calibration device and a second layer of flexible straps, the first and second layers of straps intercross in the manner of an extendable lattice grate in which the intercrossing points are connected in an articulated manner. The first or second layers of straps are fastened in an articulated manner on an axially adjustable rigid retaining ring at the end of a calibration sleeve, and the straps of the other layer end at an axial distance from the retaining ring. Such a calibration sleeve has an inside diameter which can be adjusted precisely while taking the contraction behavior of the extruded pipe into account. The straps of the first and second layer are fastened in a stationary and in an articulated manner at the intake of the calibration sleeve.

### CROSS-REFERENCE TO RELATED APPLICATIONS

This application claims the priority of German application no. 10 2005 062 138.4, filed 22 Dec. 2005, and which is incorporated herein by reference.

### FIELD OF THE INVENTION

This invention relates to a calibration sleeve for extruded plastic pipes. Further, the invention relates to a calibration sleeve for extruded plastic pipes that can be precisely adjusted.

### BACKGROUND OF THE INVENTION

Calibration sleeves are known from the prior art whose inside diameter can be changed to a limited degree during use. By changing the inside diameter of the calibration sleeve, it is possible to produce plastic pipes within the required tolerances while taking contraction into account that is determined by different factors and the type of plastic material used. Examples of such calibration sleeves can be found in DE 203 17 941 U1, DE 203 05 616 U1, DE 200 23 052 U1, DE 200 23 052 U1, DE 200 00 872 U1, and EP 1 157 805 A1. The disadvantage of these calibration sleeves is that the cross-section of the plastic pipes produced with such sleeves exhibit deviations.

U.S. Pat. No. 2,981,975 discloses a calibration sleeve that includes a first and a second set of flexible straps that run diagonal to the longitudinal axis of the calibration sleeve wherein the straps of both layers are arranged like a basket weave, i.e. the straps of both layers alternately are guided from the inside to the outside of the calibration sleeve, causing them to interlace. The straps of both layers are not connected at these interlacing points and only are fixed in an articulated manner at their ends on an intake ring or a discharge ring respectively. While the discharge ring is stationary, the intake ring is axially movable like a piston. It can be impinged upon with a source of power, e.g. a compressed air source, so that it can execute a fast, back and forth motion in an axial direction. The pulsating movement of the intake ring causes the straps on both sets to carry out a pulsating movement in radial direction within tight limits, causing them, based on the frequency of this motion, to be in contact with the outside surface of the extruded material or not to have contact with it at all. In a different embodiment, the same effect is achieved by a back-and-forth torsional movement of the intake ring.

DE 103 13 137 B3 discloses a calibration sleeve that is designed for changing dimensions during production, i.e. there is a large adjustment range that allows changing from one pipe diameter to another pipe diameter without interrupting production. In this manner, the interlacing, coupled straps of both sets guarantee an absolute round cross-section for all set cross-sections for the pipes that are produced. Although this calibration sleeve is not designed for this, it also is possible, of course, to account for the contraction of the plastic material by making corresponding, minor adjustments to the calibration sleeve.

A calibration sleeve of this type is disclosed in DE 10 2004 029 498 B3. It also is designed to allow for changing dimensions during production and is characterized in that its intake head includes radially adjustable segments so as to avoid compression of the extruded plastic pipe in the intake area.

### OBJECTS AND SUMMARY OF THE INVENTION

An object of the present invention is to provide another calibration sleeve of this type whose inside diameter can easily be adjusted with a high degree of accuracy while taking the contraction behavior of the extruded pipe into consideration.

The object of the invention is achieved by a calibration sleeve for extruded plastic pipes, that includes a first layer of flexible straps that run diagonal to a longitudinal axis of the calibration sleeve, as well as a second layer of flexible straps. The straps of the first layer intercross with the straps of the second layer at intercrossing points in the manner of an extendable lattice grate, and the intercrossing points are connected in an articulate manner. The flexible straps of one of the first and the second layer are fastened in an articulated manner on a rigid retaining ring at the end of the calibration sleeve that is axially adjustable, and the straps of the other one of the first and the second layer end at an axial distance from the retaining ring. The straps of the first and second layer are fastened in an articulated manner at the intake of the calibration sleeve. The intake includes a rigid, annular intake head.

It has been found that by axially adjusting the retaining ring that is arranged at the output of the calibration sleeve said calibration sleeve can be compressed or pulled apart, respectively, so that—beginning at the intake—a converging or diverging diameter of the calibration sleeve is obtained. The changes to the diameter of the calibration sleeve that are obtained by axially moving the retaining ring are completely sufficient to produce the plastic pipes within the required tolerances while accounting for the contraction of the plastic material. Due to the inherent stiffness of the strap layers that are arranged in a lattice grate manner, it is possible to produce plastic pipes with exact, round cross-sections.

The invention is explained in more detail below based on an exemplary embodiment.

### BRIEF DESCRIPTION OF THE DRAWINGS

FIG. 1 shows extrusion equipment for producing plastic pipes with the main components being shown schematically,

FIG. 2 shows a magnified section A according to FIG. 1 in a partial cross section with the calibration sleeve being in a neutral position, and

FIG. 3 shows a view according to FIG. 2 with a maximally compressed calibration sleeve, and

FIG. 4 shows a view according to FIG. 2 with a calibration sleeve that is pulled apart as far as possible.

### DETAILED DESCRIPTION OF THE INVENTION

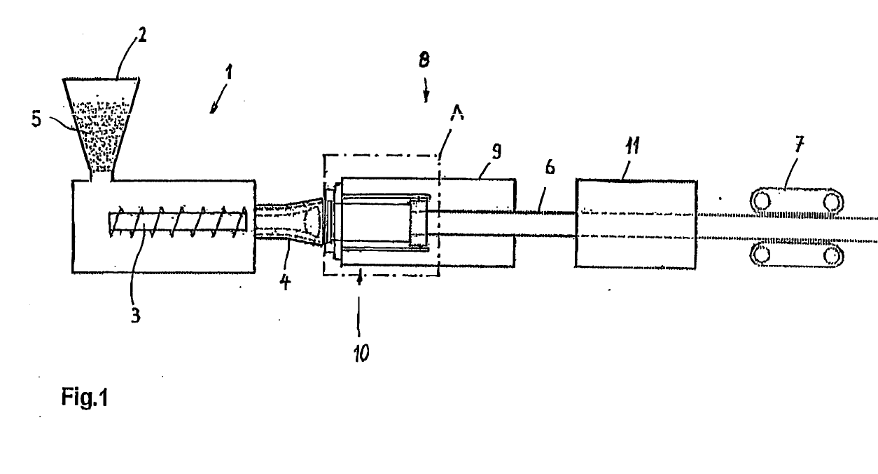

The extrusion equipment shown in FIG. 1 includes an extrusion unit 1 with a feeding bin 2, an extrusion screw 3 and an extrusion tool 4. Thermoplastic plastic material 5 in granular or powder form is introduced into the extrusion unit 1 by way of the feeding bin 2. The granulate or powder is heated, kneaded, and plasticized in the extrusion unit 1. Then the barrel extruder 3 transports the now ductile plastic mass to the extrusion tool 4, where it is pushed through an annular gap.

After the material leaves the extrusion tool 4, the hot, still ductile pipe is pulled through a calibration and cooling unit 8 by way of a drawing off unit 7 arranged at the end of the extrusion line with the calibration and cooling unit including a vacuum tank 9 with a calibration sleeve 10 arranged at its intake. After leaving the calibration and cooling unit 8, the pipe 6 enters a cooling stretch 11 where the pipe is cooled to room temperature.

Due to the cooling down the pipe 6 that exits the extrusion tool 4 is subject to a contraction process that is influenced by different factors such as the type of the extruded plastic material, the extrusion speed, the wall thickness of the plastic pipe, the temperature of the cooling water, and the vacuum in the calibration and cooling unit 8. Therefore, the extruded plastic pipes are subject to large tolerance fluctuations when rigid calibration sleeves 10 are used or, in the alternative, calibration sleeves with different diameters must be used based on the corresponding contraction behavior. To avoid this disadvantage, the diameters of the calibration sleeves according to the prior art can be adjusted. This also applies to the calibration sleeve 10 used in the extrusion equipment according to FIG. 1, whose design is explained in more detail below.

The calibration sleeve 10 has a rigid, annular intake head 12 and a rigid, annular discharge head 13. The diameter of the discharge head 13 is somewhat larger than the smallest diameter of the cone-shaped intake head 12 so as not to hinder the exit of the extruded pipe 6 from the calibration sleeve 10.

The intake head 12 is screwed to a mounting flange 14 that has a passage opening 15 for the extruded pipe 6. In order to cool the intake head 12 and simultaneously provide a lubricating film made of water to provide for glide cooling of the extruded pipe 6, the intake head 12 includes a water supply with an annular channel 16 that supplies a groove 17 with water, with the groove being open relative to the surface of the pipe.

The discharge head 13 is axially adjustable. To this end, two diametrically opposed nut-spindle adjustment mechanisms 18, hereinafter referred to as “adjustment mechanisms” are arranged. Each adjustment mechanism 18, 19 includes a nut 20 and a threaded spindle 21. By turning the threaded spindle 21 into one or the other direction, the nut 20 is either pulled into a housing 22 or moved out of it respectively.

The threaded spindle 21 of the adjustment mechanism 18 is driven directly via a connecting shaft 23 that extends between the mounting flange 14 and a first assembly disk 24. On the end that faces away from the mounting flange 14 it is connected to the end of the threaded spindle 21 in a stationary manner. On this end, the threaded spindle 21 is guided in a bearing 39 that is fastened to the first assembly disk 24. A second assembly disk 25 is arranged at a distance to the first assembly disk 24 with the housings 22 of the adjustment mechanisms 18 and 19 being flanged to the second assembly disk. A toothed belt wheel 26 is arranged on the threaded spindle 21 between the first assembly disk 24 and the second assembly disk 25 in a fixed manner with a toothed belt, which is not shown, being guided over it across a multitude of deflection rollers 27, of which only one is shown in the drawing, to the adjustment mechanism 19 on the other side. There another toothed belt wheel 28 is arranged in a fixed manner on the threaded spindle 21, which also is guided in a bearing 29 that is flanged to the assembly disk 24 at the end that faces away from the nut 20. On this side of the calibration sleeve 10, a distance sleeve 30 extends between the mounting flange 14 and the first assembly disk 24.

The adjustment mechanisms 18 and 19 are driven manually by way of a crank, which is not shown, that can be inserted on a shoulder 31. This shoulder 31 runs through the mounting flange 14 and is arranged in a pivoting manner in a bearing 32 that is screwed to the mounting flange 14. The spacer shaft 23 is arranged in a fixed manner with the end of the shoulder 31 that extends from the bearing 32.

Two strap layers 33, 34 are arranged between the intake head 12 and the discharge head 13 with the straps crossing like a lattice grate and being connected in an articulated manner at the interlacing points. Together the two strap layers 33, 34 form a perforated hollow cylinder 37 on whose inside strap layer 33 and on whose outside strap layer 34 is arranged. The ends of the straps of both strap layers 33, 34 are fastened in an articulated manner to angle 35 on the side of the intake head 12 with the angles being screwed to the assembly flange 14 on the circumference of the passage opening 15.

A rigid retaining ring 36 is arranged on the side of the discharge head 13 with the ring being connected to the discharge head 13. The retaining ring 36 is used to fasten the ends of the straps of strap layer 33 that are fastened in an articulated manner to the inside of the retaining ring 36. The ends of the straps of strap layer 34 do not extend to the retaining ring 36 on the side of the discharge head 13 but rather end at an axial distance from it and their ends are fastened in an articulated manner to the straps of strap layer 33.

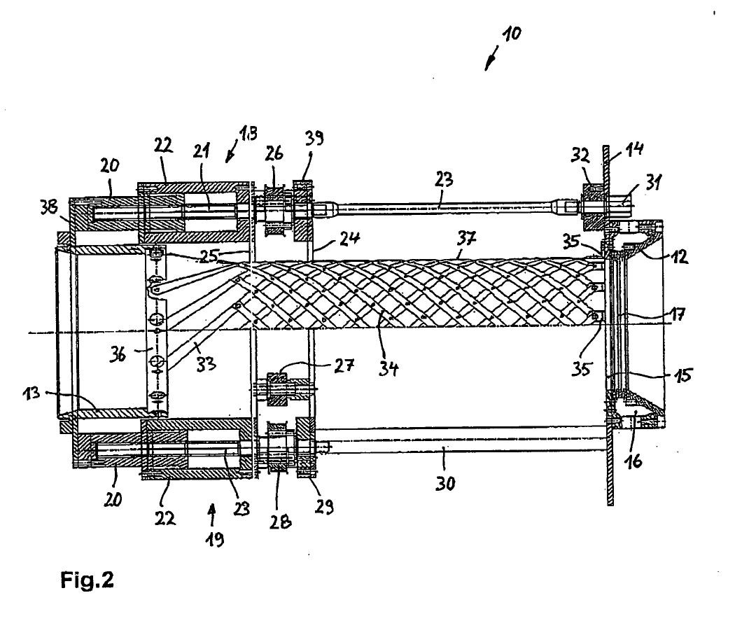

FIG. 2 shows a neutral setting of the calibration sleeve 10. In this setting the hollow cylinder 37 that is formed by the two strap layers 33, 34, has a constant diameter across its entire length with the diameter being determined by the fastening points of the strap layers 33, 34 on the mounting angles 35 and with the exception being the ends of strap layer 33 that form a discharge cone and are fastened to the retaining ring 36.

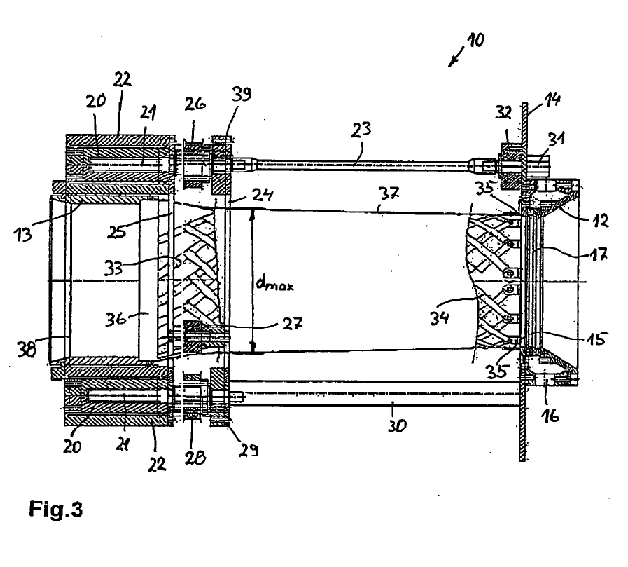

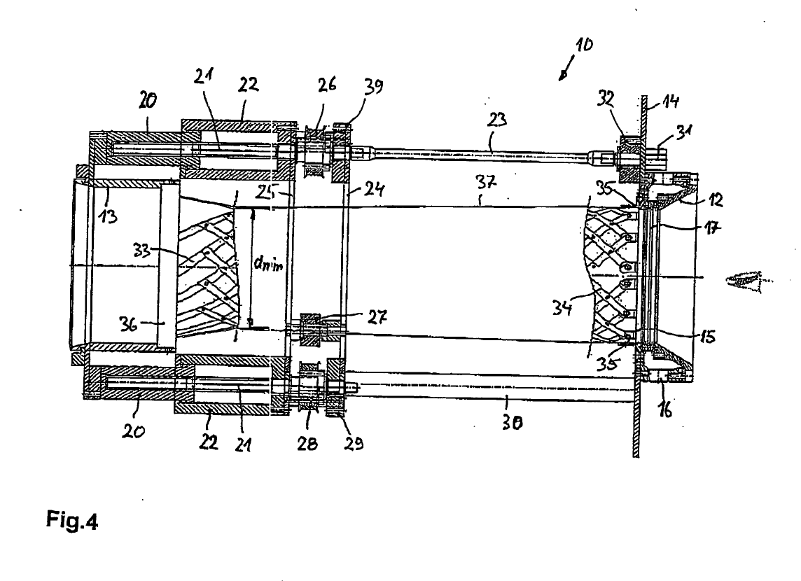

If it is necessary to change the diameter of the hollow cylinder 37 to adjust it to the contraction of a calibrated pipe 6, the adjustment mechanisms 18, 19 are adjusted accordingly. FIGS. 3 and 4 show the two possible maximum adjustments. In case of an adjustment according to FIG. 3, the nut 20 is moved completely into the housing 22, which causes the discharge head 13 fastened to the end of the nuts 20 via a flange 38 to be displaced axially towards to the greatest extent possible in relation to the intake head 12. This causes a compression of the strap layers 33, 34 of the hollow cylinder 37, which causes a slight conic expansion of the hollow cylinder 37 in the direction of the discharge head 13 due to the tolerance on the interlacing points of the strap layers 33, 34. This results in a diameter of dₘₐₓ that determines the outside diameter of the calibrated pipe 6 and is larger than the diameter of the hollow cylinder 37 on the side of the intake head 12.

In the situation shown in FIG. 4 the nuts 20 are extended as much as possible from the housings 22, i.e. the discharge head 13 has been displaced away from the intake head 12 to the greatest extent possible. This causes tension on the strap layers 33, 34 which results in a restriction of the hollow cylinder 37 on the side of the discharge head 13. This causes the hollow cylinder 37 to have a converging shape, beginning on the side of the intake head 12, with a minimum diameter dmin on the side of the discharge head 13. It is understood that of course all intermediate positions between the maximum settings according to FIGS. 3 and 4 can be set as well.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Calibration sleeve for extruded plastic pipes, comprising:
a) a first layer of flexible straps that run diagonal to a longitudinal axis of the calibration sleeve;
b) a second layer of flexible straps;
c) the straps of the first layer intercrossing with the straps of the second layer at intercrossing points in the manner of an extendable lattice grate;
d) the intercrossing points being connected in an articulate manner;
e) the flexible straps of one of the first and the second layer being fastened in an articulated manner on a rigid retaining ring at the end of the calibration sleeve that is axially adjustable;
f) the straps of the other one of the first and the second layer end at an axial distance from the retaining ring;
g) the straps of the first and second layer being fastened in an articulated manner at the intake of the calibration sleeve; and
h) the intake including a rigid, annular intake head.

2. Calibration sleeve for extruded plastic pipes according to claim 1, wherein:
a) the first and the second layers are configured for ensuring a round cross-section for extruded plastic pipes which are produced, in use.
